(19) United States
(12) Patent Application Publication
(10) Pub. No.: US 2019/0097765 A1
(43) Pub. Date: Mar. 28, 2019

(54) Method And Apparatus For Detecting Poor Channel Conditions In Uplink Grant-Free Transmission

(71) Applicant: MediaTek Singapore Pte. Ltd., Singapore (SG)

(72) Inventors: Pradeep Jose, Cambridge (GB); Mehmet Kunt, Cambridge (GB); Mohammed S Aleabe Al-Imari, Cambridge (GB); Abdelkader Medles, Cambridge (GB); Abdellatif Salah, Cambridge (GB); Arnaud Cupillard, Cambridge (GB)

(21) Appl. No.: 16/140,527

(22) Filed: Sep. 24, 2018

Related U.S. Application Data
(60) Provisional application No. 62/562,519, filed on Sep. 25, 2017.

(51) Int. Cl. H04L 1/18; H04L 1/00; H04W 72/04; H04W 24/08

(52) U.S. Cl. CPC H04L 1/1848; H04L 1/1832; H04L 1/0005; H04W 24/08; H04L 1/0017; H04W 72/042; H04L 1/0011

(57) ABSTRACT

Various solutions for detecting poor channel conditions for grant-free transmission with respect to user equipment and network apparatus in mobile communications are described. An apparatus may perform a grant-free transmission to transmit at least one of repetitions to a network node. The apparatus may initiate a count value when performing the grant-free transmission. The apparatus may determine whether the count value reaches a threshold value. The apparatus may detect that a poor channel condition is satisfied when the count value reaches the threshold value. The apparatus may perform a channel recovery mechanism in response to the poor channel condition.

### CROSS REFERENCE TO RELATED PATENT APPLICATION(S)

The present disclosure is part of a non-provisional application claiming the priority benefit of U.S. Patent Application No. 62/562,519, filed on 25 Sep. 2017, the content of which is incorporated by reference in its entirety.

### TECHNICAL FIELD

The present disclosure is generally related to mobile communications and, more particularly, to detecting poor channel conditions for grant-free transmission with respect to user equipment and network apparatus in mobile communications.

### BACKGROUND

Unless otherwise indicated herein, approaches described in this section are not prior art to the claims listed below and are not admitted as prior art by inclusion in this section.

In New Radio (NR), ultra-reliable and low latency communications (URLLC) is supported for emerging applications that demands high requirements on end-to-end latency and reliability. A general URLLC reliability requirement for one transmission of a packet is 1-10⁻⁵ for 32 bytes with a user plane latency of 1 ms. For URLLC, the target for user plane latency should be 0.5 ms for uplink and 0.5 ms for downlink.

The uplink grant-free transmission or the semi-persistent scheduling (SPS) transmission can be used to reduce the latency of URLLC services. The user equipment (UE) may be configured to transmit its uplink data on the configured grant without transmitting a prior request to improve the transmission latency. The network may pre-configure specific radio resources (e.g., time and frequency resources) for the UE to perform the SPS/grant-free transmissions.

In order to increase the reliability or the robustness for the URLLC transmissions, the UE may be configured to transmit repetitions for uplink information. For example, uplink grant-free transmissions may be configured with K repetitions in NR. The UE may attempt to transmit the data repetitions on the grant-free resources without knowledge of the channel state of the uplink connection. In a case that the modulation and coding scheme (MCS) for the grant-free transmission is not appropriate for the UE's channel conditions, the UE's transmissions may not be detected by the network apparatus. In a case that the UE assumes that the uplink data has successfully reached the network apparatus after the K repetitions without any feedback, the UE may never detect a loss of connection with the network apparatus. This may especially be true when the supplementary uplink operation is taking place and the downlink channel conditions detectable by the UE does not reflect the uplink channel conditions.

Accordingly, how the UE detects poor channel conditions based on the unacknowledged uplink grant-free transmissions may need to be overcome when developing a new generation communication system. Therefore, it is needed to provide proper channel detecting mechanisms and recovery mechanisms for the uplink grant-free transmission.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to detecting poor channel conditions for grant-free transmission with respect to user equipment and network apparatus in mobile communications.

In one aspect, a method may involve an apparatus performing a grant-free transmission to transmit at least one of repetitions to a network node. The method may also involve the apparatus initiating a count value when performing the grant-free transmission. The method may further involve the apparatus determining whether the count value reaches a threshold value. The method may further involve the apparatus detecting that a poor channel condition is satisfied when the count value reaches the threshold value. The method may further involve the apparatus performing a channel recovery mechanism in response to the poor channel condition.

In one aspect, an apparatus may comprise a transceiver capable of wirelessly communicating with a plurality of nodes of a wireless network. The apparatus may also comprise a processor communicatively coupled to the transceiver. The processor may be capable of performing a grant-free transmission to transmit at least one of repetitions to a network node. The processor may also be capable of initiating a count value when performing the grant-free transmission. The processor may further be capable of determining whether the count value reaches a threshold value. The processor may further be capable of detecting that a poor channel condition is satisfied when the count value reaches the threshold value. The processor may further be capable of performing a channel recovery mechanism in response to the poor channel condition.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a block diagram of an example communication apparatus and an example network apparatus in accordance with an implementation of the present disclosure.

FIG. 4 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to detecting poor channel conditions for grant-free transmission with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

In NR, the network node may configure two types of uplink grants for the UE to perform uplink transmissions. The uplink grant may indicate some specific radio resources (e.g., time and frequency resources) for the UE to perform uplink transmission. One type of the uplink grant may comprise the dynamic grant. The dynamic grant may be configured based on the UE's request. For example, the UE may transmit a prior request (e.g., service request (SR), random-access channel (RACH) request or buffer status report (BSR)) to the network. After receiving the request, the network may configure the dynamic grant according to UE's request for the UE to perform uplink data transmission.

The other type of the uplink grant may comprise the configured grant. The configured grant may be configured by the network without UE's request. The uplink transmission based on the configured grant may be called the grant-free transmission or the SPS transmission. For example, the uplink grant-free transmission or the SPS transmission may be used to reduce the latency of URLLC services. The UE may be configured to transmit its uplink data on the configured grant without transmitting a prior request to improve the transmission latency. The network may pre-configure specific radio resources (e.g., time and frequency resources) for the UE to perform the SPS/grant-free transmissions.

In order to increase the reliability or the robustness for the URLLC transmissions, the UE may be configured to transmit at least one of repetitions for uplink information. For example, uplink grant-free transmissions may be configured with K repetitions in NR. The UE may attempt to transmit the data repetitions on the grant-free resources without knowledge of the channel state of the uplink connection. In a case that the modulation and coding scheme (MCS) for the grant-free transmission is not appropriate for the UE's channel conditions, the UE's transmissions may not be detected by the network apparatus. In a case that the UE assumes that the uplink data has successfully reached the network apparatus after the K repetitions without any feedback, the UE may never detect a loss of connection with the network apparatus. This may especially be true when the supplementary uplink operation is taking place and the downlink channel conditions detectable by the UE does not reflect the uplink channel conditions. Accordingly, how the UE detects poor channel conditions for the uplink grant-free transmission will be described in the following paragraphs.

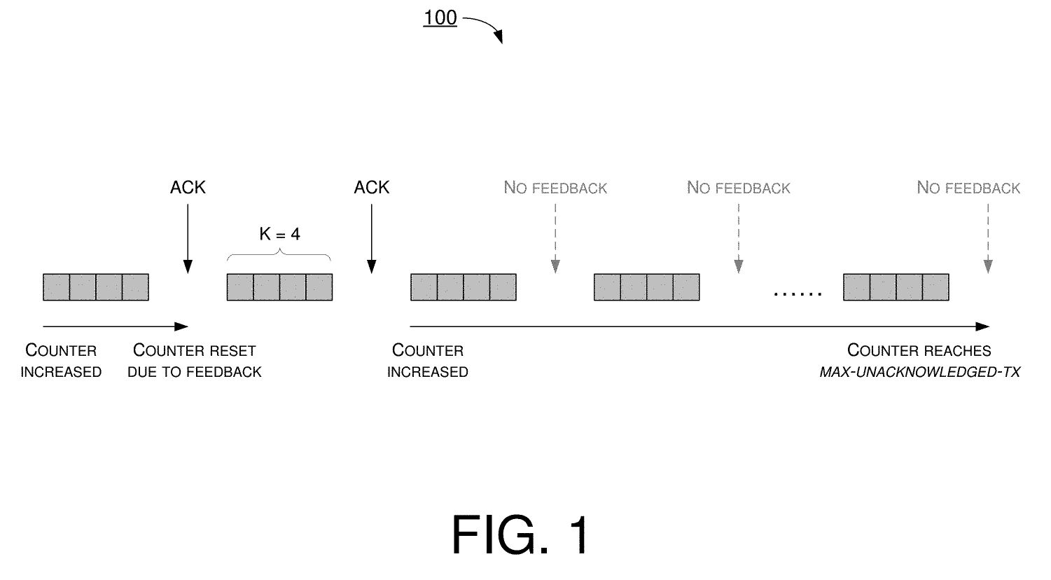

FIG. 1 illustrates an example scenario 100 under schemes in accordance with implementations of the present disclosure. Scenario 100 involves a UE and a network node, which may be a part of a wireless communication network (e.g., an LTE network, an LTE-Advanced network, an LTE-Advanced Pro network, a 5G network, an NR network, an IoT network or an NB-IoT network). The UE may be configured to perform the grant-free transmissions to transmit at least one of repetitions to the network node. For example, the grant-free transmissions may be configured with 4 repetitions (e.g., K=4). The UE may be configured to initiate a count value when performing the grant-free transmission. The UE may initiate the count value when the grant-free transmission starts. The UE may increase the count value when a repetition or a group of repetitions is transmitted. The UE may reset the count value in response to receiving a feedback from the network node. The UE may further determine whether the count value reaches a threshold value. Then, the UE may be configured to detect that a poor channel condition is satisfied when the count value reaches the threshold value. After detecting that the poor channel condition is satisfied, the UE may be configured to perform a channel recovery mechanism in response to the poor channel condition.

For example, the count value may comprise a counter. The UE may initiate the counter when the grant-free transmission starts. The UE may increase the counter at the end of a single transmission. The UE may also increase the counter after transmitting K repetitions (e.g., 4 repetitions) and receiving no feedback from the network node. The UE may reset the counter when a feedback from the network node is received. The feedback may comprise any message received from the network node. For example, the feedback may be a positive acknowledgement (ACK), a negative acknowledgement (NACK) or a response message. Alternatively, the UE may reset the counter only when a positive feedback (e.g., ACK) is received from the network node. When the counter reaches the threshold value (e.g., max-unacknowledged-tx), it means that the UE may not receive any feedback from the network node for a period of time. The uplink channel condition may become bad and the network node may not be able to detect the uplink transmissions. Accordingly, the UE may be configured to detect that the poor channel condition is satisfied when the counter reaches the threshold value. The threshold value may be a predetermined value or configured by the network node.

Alternatively, the count value may comprise a timer. The UE may initiate the timer when the grant-free transmission starts. The UE may also initiate the timer at the end of a single transmission or after transmitting K repetitions (e.g., 4 repetitions). The UE may stop the timer when a feedback from the network node is received. Similarly, the feedback may comprise any message received from the network node (e.g., ACK, NACK, response message, etc.). Alternatively, the UE may stop the timer only when a positive feedback (e.g., ACK) is received from the network node. When the timer is expired, it means that the UE may not receive any feedback from the network node for a period of time. The uplink channel condition may become bad and the network node may not be able to detect the uplink transmissions. Accordingly, the UE may be configured to detect that the poor channel condition is satisfied when the timer is expired. The timer value may be a predetermined value or configured by the network node.

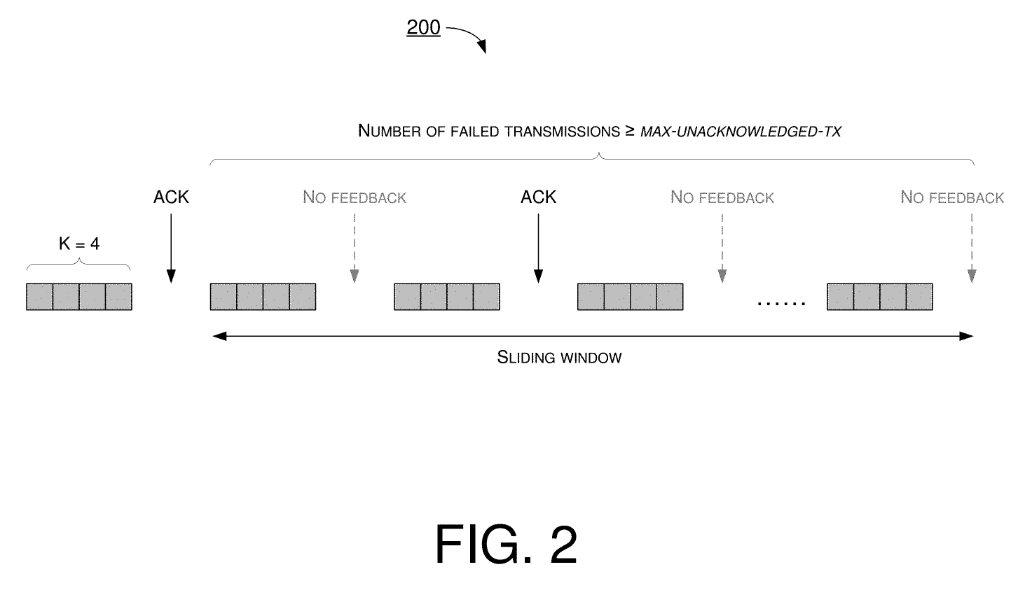

Alternatively, the count value may comprise a sliding window mechanism. FIG. 2 illustrates an example scenario 200 under schemes in accordance with implementations of the present disclosure. Scenario 200 involves a UE and a network node, which may be a part of a wireless communication network (e.g., an LTE network, an LTE-Advanced network, an LTE-Advanced Pro network, a 5G network, an NR network, an IoT network or an NB-IoT network). The UE may initiate the sliding window mechanism when the grant-free transmission starts. The sliding window mechanism may be implemented by counting the number of failed transmission within a duration. The UE may increase the count value when an uplink grant-free transmission is determined as failed. For example, after transmitting a repetition or a group of repetitions (e.g., K repetitions) without receiving a feedback from the network node, the UE may determine that the grant-free transmission is failed and increase the count value by 1. In a case that the UE receive a feedback after transmitting a repetition or a group of repetitions (e.g., K repetitions), the UE may determine that the grant-free transmission is successful and may not increase the count value. Similarly, the feedback may comprise any message received from the network node (e.g., ACK, NACK, response message, etc.). The UE may keep monitoring the grant-free transmissions within the duration (e.g., sliding window). When the count value (e.g., number of failed transmission) within the window duration is equal to or greater than the threshold value (e.g., max-unacknowledged-tx), it means that the grant-free transmissions may be failed for several times within a period of time. The uplink channel condition may become bad and the network node may not be able to detect the uplink transmissions very well. The UE may reset the sliding window mechanism when the feedbacks received from the network node reaches a predetermined value. It means that the grant-free transmissions may be successful within a period of time and the uplink channel condition may be good. Accordingly, the UE may be configured to detect whether the poor channel condition is satisfied according to the sliding window mechanism. The number of failed transmissions and the sliding window duration may be predetermined or configured by the network node.

After detecting that the poor channel condition is satisfied, the UE may be further configured to perform the channel recovery mechanism in response to the poor channel condition. Specifically, the channel recovery mechanism may comprise transmitting a service request (SR) to the network node. The UE may use the SR to indicate or reflect the poor channel condition. After receiving the SR, the network node may be aware of the issue for the grant-free configuration. The network node may be able to re-configure the grant-free resources for better channel conditions.

Alternatively, the channel recovery mechanism may comprise transmitting a message to inform the network node of the grant-free configuration failure. The message may comprise a medium access control (MAC) control element (CE) message or a radio resource control (RRC) message. The UE may use the MAC CE message or RRC message to indicate the poor channel condition or the grant-free configuration failure.

Alternatively, the channel recovery mechanism may comprise falling back to a grant-based operation. After detecting that the poor channel condition is satisfied, the UE may be configured to suspend the use of the grant-free configuration and fall back to the grant-based operation. The UE may temporarily use the grant-based resources to perform the uplink data transmissions and wait for new grant-free configurations from the network node.

Alternatively, the channel recovery mechanism may comprise triggering a radio link failure procedure. After detecting that the poor channel condition is satisfied, the UE may assume that the link between the UE and the network node has failed and trigger a radio link failure procedure. The UE may be configured to re-establish the connection with the network node.

Alternatively, after detecting that the poor channel condition is satisfied, the UE may be configured to start a counter to count the number of feedbacks (e.g., ACKs) received from the network node within a period of time. The UE may also start a timer for the counter. In a case that the number of feedbacks received from the network node reaches a predetermined value (e.g., max-num-feedback-in-sync), the UE may determine that the poor channel condition is not satisfied. The UE may assume that it is out of the poor channel condition. In a case that the timer is expired and the counter is less than the predetermined value (e.g., max-num-feedback-in-sync), the UE may be configured to perform one or some of the channel recovery mechanisms as described above.

### Illustrative Implementations

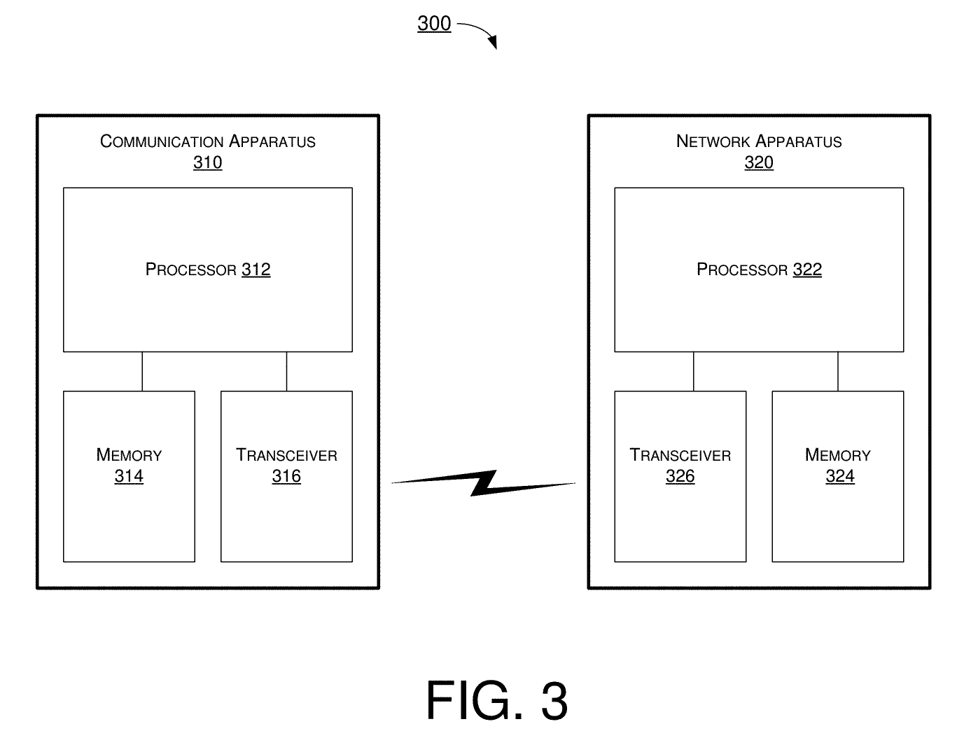

FIG. 3 illustrates an example communication apparatus 310 and an example network apparatus 320 in accordance with an implementation of the present disclosure. Each of communication apparatus 310 and network apparatus 320 may perform various functions to implement schemes, techniques, processes and methods described herein pertaining to detecting poor channel conditions for grant-free transmission with respect to user equipment and network apparatus in wireless communications, including scenarios 100 and 200 described above as well as process 400 described below.

Communication apparatus 310 may be a part of an electronic apparatus, which may be a UE such as a portable or mobile apparatus, a wearable apparatus, a wireless communication apparatus or a computing apparatus. For instance, communication apparatus 310 may be implemented in a smartphone, a smartwatch, a personal digital assistant, a digital camera, or a computing equipment such as a tablet computer, a laptop computer or a notebook computer. Communication apparatus 310 may also be a part of a machine type apparatus, which may be an IoT or NB-IoT apparatus such as an immobile or a stationary apparatus, a home apparatus, a wire communication apparatus or a computing apparatus. For instance, communication apparatus 310 may be implemented in a smart thermostat, a smart fridge, a smart door lock, a wireless speaker or a home control center. Alternatively, communication apparatus 310 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 310 may include at least some of those components shown in FIG. 3 such as a processor 312, for example. communication apparatus 310 may further include one or more other components not pertinent to the proposed scheme of the present disclosure (e.g., internal power supply, display device and/or user interface device), and, thus, such component(s) of communication apparatus 310 are neither shown in FIG. 3 nor described below in the interest of simplicity and brevity.

Network apparatus 320 may be a part of an electronic apparatus, which may be a network node such as a base station, a small cell, a router or a gateway. For instance, network apparatus 320 may be implemented in an eNodeB in an LTE, LTE-Advanced or LTE-Advanced Pro network or in a gNB in a 5G, NR, IoT or NB-IoT network. Alternatively, network apparatus 320 may be implemented in the form of one or more IC chips such as, for example and without limitation, one or more single-core processors, one or more multi-core processors, or one or more RISC or CISC processors. Network apparatus 320 may include at least some of those components shown in FIG. 3 such as a processor 322, for example. Network apparatus 320 may further include one or more other components not pertinent to the proposed scheme of the present disclosure (e.g., internal power supply, display device and/or user interface device), and, thus, such component(s) of network apparatus 320 are neither shown in FIG. 3 nor described below in the interest of simplicity and brevity.

In one aspect, each of processor 312 and processor 322 may be implemented in the form of one or more single-core processors, one or more multi-core processors, or one or more CISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks including power consumption reduction in a device (e.g., as represented by communication apparatus 310) and a network (e.g., as represented by network apparatus 320) in accordance with various implementations of the present disclosure.

In some implementations, communication apparatus 310 may also include a transceiver 316 coupled to processor 312 and capable of wirelessly transmitting and receiving data. In some implementations, communication apparatus 310 may further include a memory 314 coupled to processor 312 and capable of being accessed by processor 312 and storing data therein. In some implementations, network apparatus 320 may also include a transceiver 326 coupled to processor 322 and capable of wirelessly transmitting and receiving data. In some implementations, network apparatus 320 may further include a memory 324 coupled to processor 322 and capable of being accessed by processor 322 and storing data therein. Accordingly, communication apparatus 310 and network apparatus 320 may wirelessly communicate with each other via transceiver 316 and transceiver 326, respectively. To aid better understanding, the following description of the operations, functionalities and capabilities of each of communication apparatus 310 and network apparatus 320 is provided in the context of a mobile communication environment in which communication apparatus 310 is implemented in or as a communication apparatus or a UE and network apparatus 320 is implemented in or as a network node of a communication network.

In some implementations, processor 312 may be configured to perform, via transceiver 316, the grant-free transmissions to transmit at least one of repetitions to the network node. For example, processor 312 may be configured to transmit, via transceiver 316, 4 repetitions (e.g., K=4). Processor 312 may be configured to initiate a count value when performing the grant-free transmission. Processor 312 may initiate the count value when the grant-free transmission starts. Processor 312 may increase the count value when a repetition or a group of repetitions is transmitted. Processor 312 may reset the count value in response to receiving a feedback from the network node. Processor 312 may further determine whether the count value reaches a threshold value. Then, processor 312 may be configured to detect that a poor channel condition is satisfied when the count value reaches the threshold value. After detecting that the poor channel condition is satisfied, processor 312 may be configured to perform a channel recovery mechanism in response to the poor channel condition.

In some implementations, processor 312 may initiate a counter when the grant-free transmission starts. Processor 312 may increase the counter at the end of a single transmission. Processor 312 may also increase the counter after transmitting K repetitions (e.g., 4 repetitions) and receiving no feedback from network apparatus 320. Processor 312 may reset the counter when a feedback from network apparatus 320 is received. The feedback may comprise any message received from network apparatus 320. For example, the feedback may be an ACK, a NACK or a response message. Alternatively, processor 312 may reset the counter only when a positive feedback (e.g., ACK) is received from the network node. When the counter reaches the threshold value (e.g., max-unacknowledged-tx), it means that processor 312 may not receive any feedback from network apparatus 320 for a period of time. The uplink channel condition may become bad and network apparatus 320 may not be able to detect the uplink transmissions. Accordingly, processor 312 may be configured to detect that the poor channel condition is satisfied when the counter reaches the threshold value. The threshold value may be a predetermined value or configured by network apparatus 320.

In some implementations, processor 312 may initiate a timer when the grant-free transmission starts. Processor 312 may also initiate the timer at the end of a single transmission or after transmitting K repetitions (e.g., 4 repetitions). Processor 312 may stop the timer when a feedback from network apparatus 320 is received. Similarly, the feedback may comprise any message received from network apparatus 320 (e.g., ACK, NACK, response message, etc.). Alternatively, processor 312 may stop the timer only when a positive feedback (e.g., ACK) is received from network apparatus 320. When the timer is expired, it means that processor 312 may not receive any feedback from network apparatus 320 for a period of time. The uplink channel condition may become bad and network apparatus 320 may not be able to detect the uplink transmissions. Accordingly, processor 312 may be configured to detect that the poor channel condition is satisfied when the timer is expired. The timer value may be a predetermined value or configured by network apparatus 320.

In some implementations, processor 312 may be configured to initiate a sliding window mechanism when the grant-free transmission starts. Processor 312 may implement the sliding window mechanism by counting the number of failed transmission within a duration. Processor 312 may increase the count value when an uplink grant-free transmission is determined as failed. For example, after transmitting a repetition or a group of repetitions (e.g., K repetitions) without receiving a feedback from the network node, processor 312 may determine that the grant-free transmission is failed and increase the count value by 1. In a case that processor 312 receive a feedback after transmitting a repetition or a group of repetitions (e.g., K repetitions), processor 312 may determine that the grant-free transmission is successful and may not increase the count value. Similarly, the feedback may comprise any message received from the network node (e.g., ACK, NACK, response message, etc.). Processor 312 may keep monitoring the grant-free transmissions within the duration (e.g., sliding window). When the count value (e.g., number of failed transmission) within the window duration is equal to or greater than the threshold value (e.g., max-unacknowledged-tx), it means that the grant-free transmissions may be failed for several times within a period of time. The uplink channel condition may become bad and network apparatus 320 may not be able to detect the uplink transmissions very well. Processor 312 may reset the sliding window mechanism when the feedbacks received from network apparatus 320 reaches a predetermined value. It means that the grant-free transmissions may be successful within a period of time and the uplink channel condition may be good. Accordingly, processor 312 may be configured to detect whether the poor channel condition is satisfied according to the sliding window mechanism. The number of failed transmissions and the sliding window duration may be predetermined or configured by network apparatus 320.

In some implementations, after detecting that the poor channel condition is satisfied, processor 312 may be further configured to perform a channel recovery mechanism in response to the poor channel condition. Specifically, processor 312 may be configured to transmit an SR to network apparatus 320. Processor 312 may use the SR to indicate or reflect the poor channel condition. After receiving the SR, network apparatus 320 may be aware of the issue for the grant-free configuration. Network apparatus 320 may be able to re-configure the grant-free resources for better channel conditions.

In some implementations, processor 312 may be configured to transmit a message to inform network apparatus 320 of the grant-free configuration failure. The message may comprise a MAC CE message or a RRC message. Processor 312 may use the MAC CE message or RRC message to indicate the poor channel condition or the grant-free configuration failure.

In some implementations, processor 312 may be configured to fall back to a grant-based operation. After detecting that the poor channel condition is satisfied, processor 312 may be configured to suspend the use of the grant-free configuration and fall back to the grant-based operation. Processor 312 may temporarily use the grant-based resources to perform the uplink data transmissions and wait for new grant-free configurations from network apparatus 320.

In some implementations, processor 312 may be configured to trigger a radio link failure procedure. After detecting that the poor channel condition is satisfied, processor 312 may assume that the link between communication apparatus 310 and network apparatus 320 has failed and trigger a radio link failure procedure. Processor 312 may be configured to re-establish the connection with network apparatus 320.

In some implementations, after detecting that the poor channel condition is satisfied, processor 312 may be configured to start a counter to count the number of feedbacks (e.g., ACKs) received from network apparatus 320 within a period of time. Processor 312 may also start a timer for the counter. In a case that the number of feedbacks received from network apparatus 320 reaches a predetermined value (e.g., max-num-feedback-in-sync), processor 312 may determine that the poor channel condition is not satisfied. Processor 312 may assume that it is out of the poor channel condition. In a case that the timer is expired and the counter is less than the predetermined value (e.g., max-num-feedback-in-sync), processor 312 may be configured to perform one or some of the channel recovery mechanisms as described above.

### Illustrative Processes

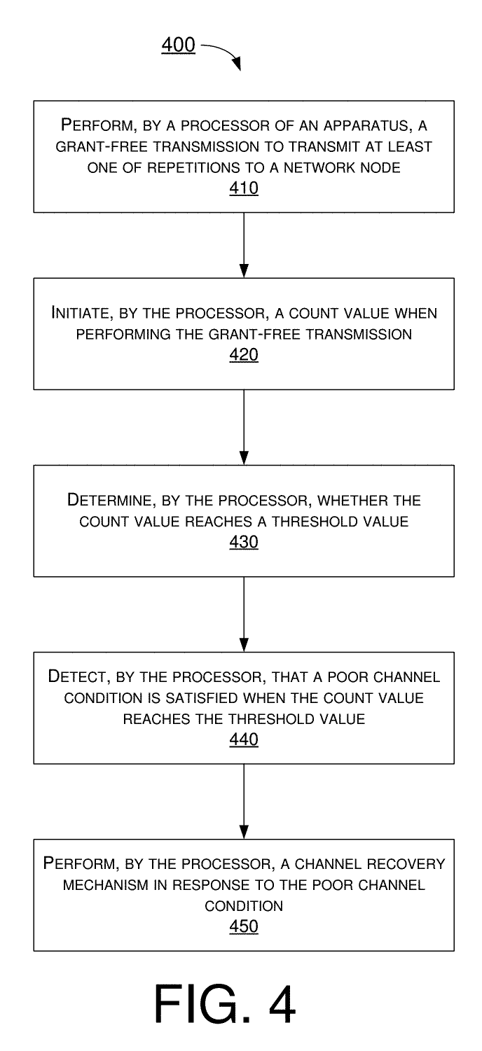

FIG. 4 illustrates an example process 400 in accordance with an implementation of the present disclosure. Process 400 may be an example implementation of scenarios 100 and 200, whether partially or completely, with respect to detecting poor channel conditions for grant-free transmission in accordance with the present disclosure. Process 400 may represent an aspect of implementation of features of communication apparatus 310. Process 400 may include one or more operations, actions, or functions as illustrated by one or more of blocks 410, 420, 430, 440 and 450. Although illustrated as discrete blocks, various blocks of process 400 may be divided into additional blocks, combined into fewer blocks, or eliminated, depending on the desired implementation. Moreover, the blocks of process 400 may executed in the order shown in FIG. 4 or, alternatively, in a different order. Process 400 may be implemented by communication apparatus 310 or any suitable UE or machine type devices. Solely for illustrative purposes and without limitation, process 400 is described below in the context of communication apparatus 310. Process 400 may begin at block 410.

At 410, process 400 may involve processor 312 of apparatus 310 performing a grant-free transmission to transmit at least one of repetitions to a network node. Process 400 may proceed from 410 to 420.

At 420, process 400 may involve processor 312 initiating a count value when performing the grant-free transmission. Process 400 may proceed from 420 to 430.

At 430, process 400 may involve processor 312 determining whether the count value reaches a threshold value. Process 400 may proceed from 430 to 440.

At 440, process 400 may involve processor 312 detecting that a poor channel condition is satisfied when the count value reaches the threshold value. Process 400 may proceed from 440 to 450.

At 450, process 400 may involve processor 312 performing a channel recovery mechanism in response to the poor channel condition.

In some implementations, the count value may comprise a counter. Process 400 may involve processor 312 increasing the count value when a repetition or a group of repetitions is transmitted.

In some implementations, the count value may comprise a timer. Process 400 may involve processor 312 detecting that the poor channel condition is satisfied when the timer is expired.

In some implementations, the count value may comprise a sliding window mechanism. Process 400 may involve processor 312 increasing the count value when a grant-free transmission is failed.

In some implementations, process 400 may involve processor 312 resetting the count value in response to receiving a feedback from the network node.

In some implementations, process 400 may involve processor 312 transmitting a service request message to the network node.

In some implementations, process 400 may involve processor 312 transmitting a message to inform the network node of a grant-free configuration failure.

In some implementations, process 400 may involve processor 312 falling back to a grant-based operation.

In some implementations, process 400 may involve processor 312 triggering a radio link failure procedure.

In some implementations, process 400 may involve processor 312 determining that a number of feedbacks received from the network node reaches a predetermined value. Process 400 may further involve processor 312 determining that the poor channel condition is not satisfied.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
performing, by a processor of an apparatus, a grant-free transmission to transmit at least one of repetitions to a network node;
initiating, by the processor, a count value when performing the grant-free transmission;
determining, by the processor, whether the count value reaches a threshold value;
detecting, by the processor, that a poor channel condition is satisfied when the count value reaches the threshold value; and
performing, by the processor, a channel recovery mechanism in response to the poor channel condition.

2. The method of claim 1, further comprising:
increasing, by the processor, the count value when a repetition or a group of repetitions is transmitted,
wherein the count value comprises a counter.

3. The method of claim 1, wherein the count value comprises a timer, and wherein the detecting comprises detecting that the poor channel condition is satisfied when the timer is expired.

4. The method of claim 1, further comprising:
increasing, by the processor, the count value when a grant-free transmission is failed,
wherein the count value comprises a sliding window mechanism.

5. The method of claim 1, further comprising:
resetting, by the processor, the count value in response to receiving a feedback from the network node.

6. The method of claim 1, wherein the performing the channel recovery mechanism comprises transmitting a service request message to the network node.

7. The method of claim 1, wherein the performing the channel recovery mechanism comprises transmitting a message to inform the network node of a grant-free configuration failure.

8. The method of claim 1, wherein the performing the channel recovery mechanism comprises falling back to a grant-based operation.

9. The method of claim 1, wherein the performing the channel recovery mechanism comprises triggering a radio link failure procedure.

10. The method of claim 1, wherein the performing the channel recovery mechanism comprises determining that a number of feedbacks received from the network node reaches a predetermined value, and determining that the poor channel condition is not satisfied.

11. An apparatus, comprising:
a transceiver capable of wirelessly communicating with a plurality of nodes of a wireless network; and
a processor communicatively coupled to the transceiver, the processor capable of:
performing, via the transceiver, a grant-free transmission to transmit at least one of repetitions to a network node;
initiating a count value when performing the grant-free transmission;
determining whether the count value reaches a threshold value;
detecting that a poor channel condition is satisfied when the count value reaches the threshold value; and
performing a channel recovery mechanism in response to the poor channel condition.

12. The apparatus of claim 11, wherein the processor is further capable of:
increasing the count value when a repetition or a group of repetitions is transmitted,
wherein the count value comprises a counter.

13. The apparatus of claim 11, wherein the count value comprises a timer, and wherein, in the detecting, the processor is further capable of detecting that the poor channel condition is satisfied when the timer is expired.

14. The apparatus of claim 11, wherein the processor is further capable of:
increasing the count value when a grant-free transmission is failed,
wherein the count value comprises a sliding window mechanism.

15. The apparatus of claim 11, wherein the processor is further capable of:
resetting the count value in response to receiving a feedback from the network node.

16. The apparatus of claim 11, wherein, in the performing the channel recovery mechanism, the processor is further capable of transmitting a service request message to the network node.

17. The apparatus of claim 11, wherein, in the performing the channel recovery mechanism, the processor is further capable of transmitting a message to inform the network node of a grant-free configuration failure.

18. The apparatus of claim 11, wherein, in the performing the channel recovery mechanism, the processor is further capable of falling back to a grant-based operation.

19. The apparatus of claim 11, wherein, in the performing the channel recovery mechanism, the processor is further capable of triggering a radio link failure procedure.

20. The apparatus of claim 11, wherein, in the performing the channel recovery mechanism, the processor is further capable of determining that a number of feedbacks received from the network node reaches a predetermined value, and determining that the poor channel condition is not satisfied.
